(19) United States
(12) Patent Application Publication
(10) Pub. No.: US 2025/0118952 A1
(43) Pub. Date: Apr. 10, 2025

(54) MODULAR CONTOUR ADAPTIVE CHANNEL ASSEMBLY

(71) Applicant: Lear Corporation, Southfield, MI (US)

(72) Inventors: Jun Roz Ruayana, Novi, MI (US); Erwin Baga-an, Cebu City (PH); Clint Rey Guevarra, Southfield, MI (US); Muhammad Ashrafi, Woodhaven, MI (US); William Bond, Livonia, MI (US); John Montgomery, Canton, MI (US)

(21) Appl. No.: 18/790,534

(22) Filed: Jul. 31, 2024

Related U.S. Application Data
(60) Provisional application No. 63/542,890, filed on Oct. 6, 2023.

(51) Int. Cl. H02G 3/04; B60R 16/02; F16L 3/015; F16L 3/26

(52) U.S. Cl. CPC H02G 3/0437; B60R 16/0215; F16L 3/015; F16L 3/26

(57) ABSTRACT

A modular contour adaptive channel assembly may include comprising a plurality of modules releasably and adjustably connected to one another in a chain-like manner to define a common cable channel. Each of the plurality of modules may include a base, a cover removably disposed on the base, and a cable passage defined between the cover and the base. The base may include a front connector, a rear connector, and a base fastener. The cover may include a cover fastener. The cover fastener and the base fastener may be engaged with one another releasably connecting the cover and base. Adjacent modules of the plurality of modules may be pivotably and releasably connected to one another via engagement of the front connector of a first module of the adjacent modules and the rear connector of a second module of the adjacent modules. The cable passages may collectively define the common cable channel.

### CROSS-REFERENCE TO RELATED APPLICATION

This application claims the benefit of and priority to U.S. Provisional Patent Application Ser. No. 63/542,890, filed on Oct. 6, 2023, the disclosure of which is hereby incorporated by reference in its entirety as though fully set forth herein.

### TECHNICAL FIELD

The present disclosure generally relates to modular channel assemblies for retaining, mounting, guiding, and/or protecting one or more cables, such as channel assemblies that may, for example, be utilized in connection with and/or incorporated into vehicles.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a perspective view generally illustrating an embodiment of a channel assembly attached to a plurality of objects according to teachings of the present disclosure.

FIG. 2 is a perspective view generally illustrating an embodiment of a module of a channel assembly according to teachings of the present disclosure.

FIG. 3 is a perspective view generally illustrating an embodiment of a cover of a module according to teachings of the present disclosure.

FIGS. 4 and 5 are perspective views generally illustrating an embodiment of a base of a module according to teachings of the present disclosure.

FIG. 6 is a perspective cross-sectional view generally illustrating an embodiment of a module retaining a plurality of cables according to teachings of the present disclosure.

FIGS. 7 and 8 are perspective cross-sectional views generally illustrating an embodiment of a module with the cover disposed in different positions according to teachings of the present disclosure.

FIGS. 9 and 10 are perspective views generally illustrating an embodiment of a pair of adjacent modules disposed in different positions relative to one another according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

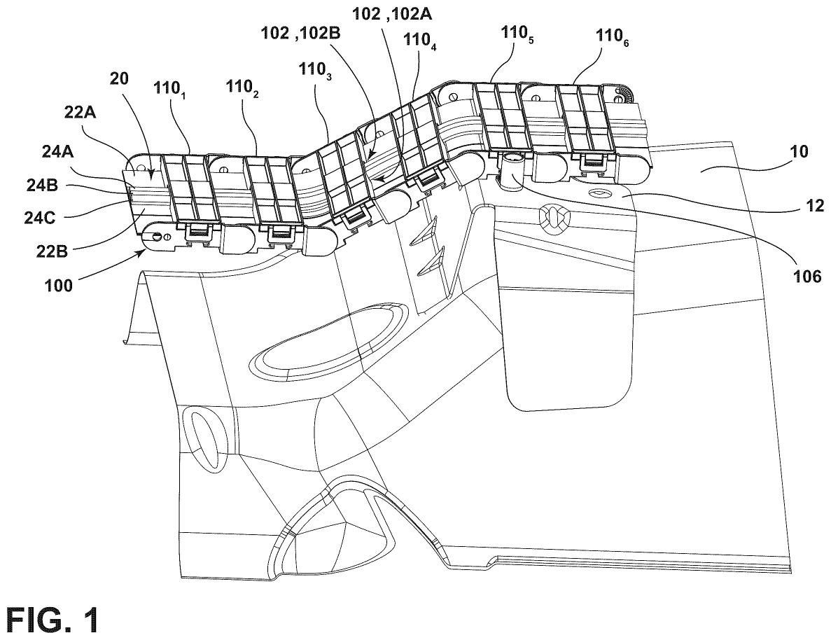

Referring to FIG. 1, a modular contour adaptive channel assembly 100 for retaining, mounting, guiding, and/or protecting one or more cables 20 is depicted. The channel assembly 100 includes a plurality of modules 110₁, 110₂, 110₃, 110₄, 110₅, 110₆ that are pivotably and releasably connected to one another in a chain-like manner. A module 110₁-110₆ may additionally and/or alternatively be considered, referred to, and/or claimed as a link, chain link, channel link, link unit, link assembly, guide assembly, guide unit, structural unit, and/or housing, among other suitable and appropriate nomenclatures. Optionally, the channel assembly 100 also includes one or more attachments 106 connected to one or more of the modules 110₁-110₆.

The channel assembly 100 and/or the modules 110₁-110₆ thereof accommodates, receives, supports, and/or is connected to a plurality of cables 20, secures and/or attaches the cables 20 to one or more objects (e.g., a support structure 10 and/or a bracket 12), and guides the cables 20 along a contour of the one or more objects 10, 12. The channel assembly 100 and/or one or more modules 110₁-110₆ thereof is attached, connected, mounted, and/or fixed to one or more support structures 10 (e.g., one or more portions of a vehicle, such as a vehicle floor and/or panel) via one or more brackets 12. Alternatively, the channel assembly 100 and/or one or more modules 110₁-110₆ may be attached and/or connected directly to one or more support structures 10.

The cables 20 may include one or more flat cables (e.g., a first flat cable 22A and a second flat cable 22B) and/or one or more non-flat cables (e.g., a first round cable 24A, a second round cable 24B, and a third round cable 24C). The flat cables 22A, 22B are flexible and each have a substantially rectangular cross-section. The non-flat cables 24A-24C are flexible and each have a round and/or substantially circular cross-section. However, one or more of the cables 20 may have other suitable configurations (e.g., nonflexible) and/or cross-sectional shapes (e.g., polygonal, trapezoidal, octagonal) in different embodiments. One or more of the cables 20 includes one or more electrical conductors overmolded and/or embedded within an insulating material that electrically insulates the conductors from each other and/or from other components. One or more of the cables 20 may be an electrical power cable that delivers power from a power source (e.g., a battery, such as a vehicle battery) to one or more electrical components.

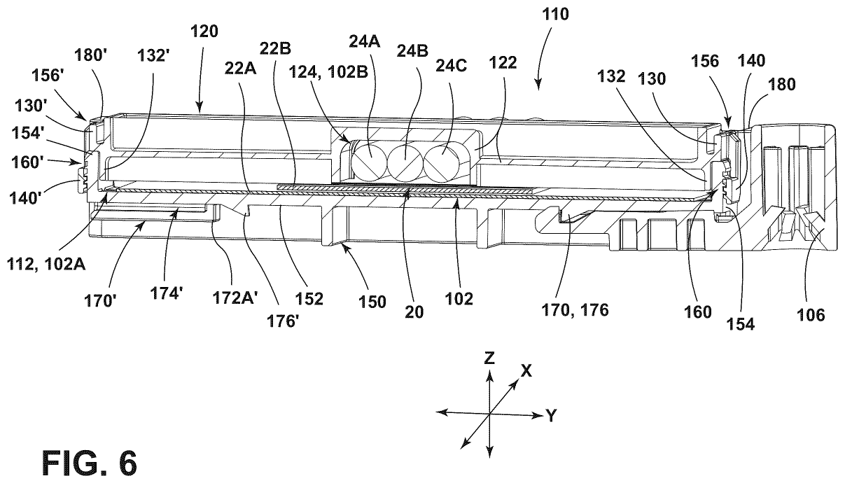

As generally illustrated in FIGS. 1 and 6, the channel assembly 100 and/or the modules 110₁-110₆ thereof defines one or more common cable channels 102. The common cable channel 102 is configured to receive and retain at least a portion of one or more cables 20 to, for example, secure and/or mount the cables 20 to an object 10, 12, protect the cables 20 (at least to an extent), and/or guide at least a portion of the cables 20 (e.g., along a contour of the object 10, 12 and/or between two locations).

The common cable channel 102 includes a first channel portion 102A and a second channel portion 102B. The channel portions 102A, 102B are portions and/or regions of a singular cable channel 102 or space, but may alternatively be separate from one another. As shown in FIGS. 1 and 6, the flat cables 22A, 22B are disposed in and extend through the first channel portion 102A, while the non-flat cables 24A-24C are disposed in and extend through the second channel portion 102B. However, one or more different types and/or shapes of cables 20 may additionally and/or alternatively be disposed in one or more of the channel portions 102A, 102B.

The cable passage 112 and/or the cable opening 124 of each of the plurality of modules 110₁-110₆ of the channel assembly 100 may collectively define at least a portion of the common cable channel 102. For example, as shown in FIGS. 1 and 6, the cable passage 112 of each of the plurality of modules 110₁-110₆ of the channel assembly 100 collectively define the first channel portion 102A. The cable opening 124 of each of the plurality of modules 110₁-110₆ of the channel assembly 100 collectively define the second channel portion 102B.

As generally illustrated in FIG. 1, the channel assembly 100 includes a plurality of modules 110₁-110₆ (e.g., housing modules) that are pivotably and releasably connected to one another in a chain-like manner. The channel assembly 100 includes any desired number of modules 110₁-110₆, which may vary depending on the situation, use, and/or environment for example. For instance, the channel assembly 100 may include a smaller number of modules 110₁-110₆ when the cables 20 extend a short distance. Alternatively, the channel assembly 100 may include a larger number of modules 110₁-110₆ when the cables 20 extend a greater distance. The number of modules 110₁-110₆ can be easily changed and/or modified as desired (e.g., to accommodate and/or account for manufacturing tolerances) due to the modular design of the channel assembly 100, making a longitudinal length of the channel assembly 100 highly adaptable and customizable.

Due to the modular design of the channel assembly 100, the channel assembly 100 can be more easily repaired, adapted, and/or customized in a cost-effective manner, such as by simply replacing and/or swapping out one or more modules 110₁-110₆ for one or more other modules 110₁-110₆. A broken and/or damaged module 110₁-110₆ may, for example, be disconnected and replaced with another module 110₁-110₆ (e.g., an identical module). As another example, a module 110₁-110₆ may be disconnected and replaced with another module 110₁-110₆ having a different design and/or configuration to facilitate assembly and/or adjust the pathway of the cables 20 (e.g., a module having an elongated linear shape may be swapped for a different module having a curved and/or S-shape, such as to guide the cables 20 around an obstacle, reduce play in the cables 20, etc.).

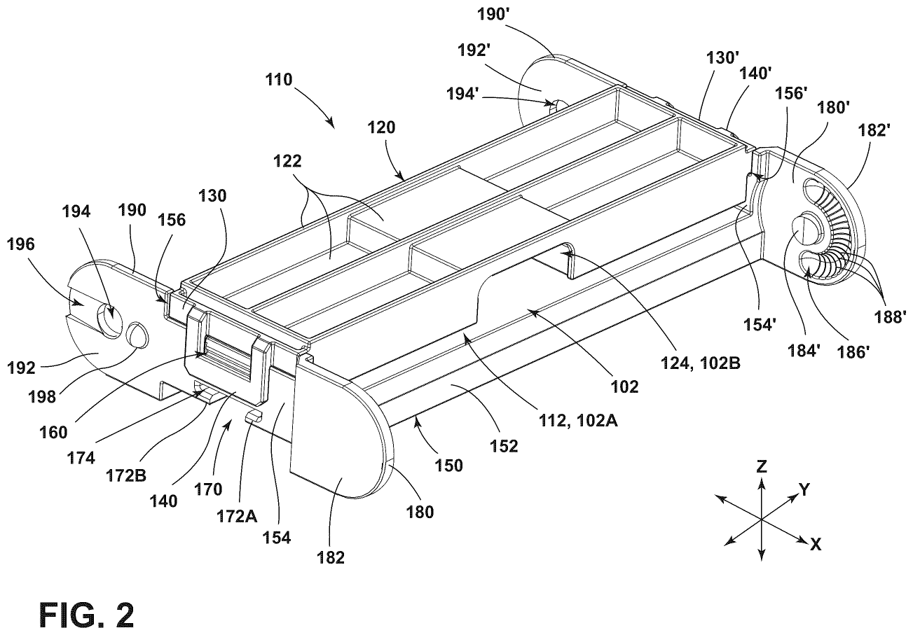

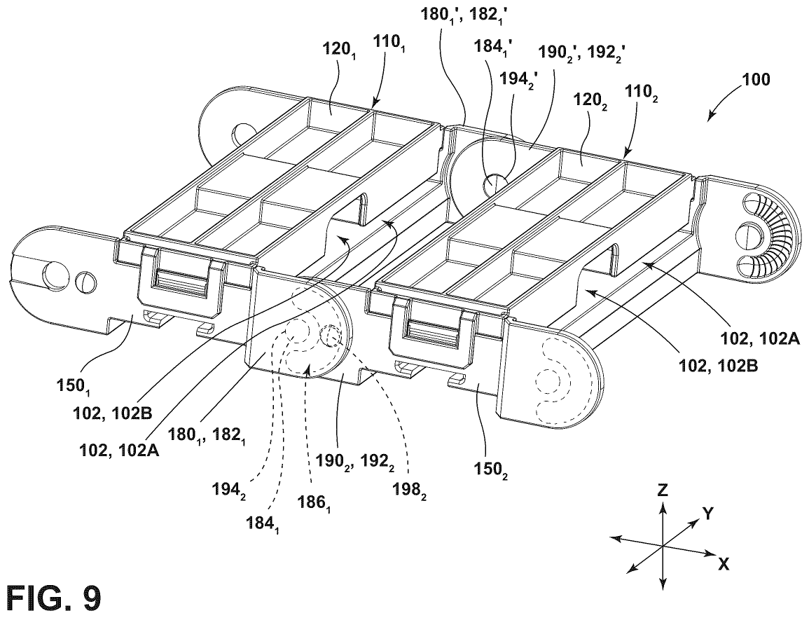

A module 110₁-110₆ of the channel assembly 100 may be configured substantially similar (e.g., identical) to one or more other modules 110₁-110₆ and/or may be configured differently than one or more modules 110₁-110₆. A module 110₁-110₆ may also include features, elements, and/or components that are substantially similar to those of one or more other modules 110₁-110₆ and/or that are different than those of one or more other modules 110₁-110₆. Nevertheless, for simplicity, the modules 110₁-110₆ of the channel assembly 100 depicted in FIGS. 1, 9, and/or 10 are substantially similar and/or identical to one another. As such, for brevity, a single module 110 that is representative of each of the plurality of modules 110₁-110₆ is depicted in FIGS. 2-8 and described below.

As generally illustrated in FIGS. 2 and 6-8, the module 110 includes a cable passage 112, a cover 120, and a base 150. The base 150 and the cover 120 are separate and independent components and/or bodies. The cover 120 is releasably and/or removably connectable to the base 150, such as to at least partially close and/or form the cable passage 112 therebetween. The module 110, the base 150, and/or the cover 120 generally has a rectangular shape. Alternatively, the module 110 (e.g., the base 150 and/or the cover 120 thereof) may have one or more other shapes such as a curved shape, a C-shape, and/or an S-shape, among others. The base 150 and the cover 120 are composed of a plastic material, but may additionally and/or alternatively be composed of and/or include one or more other materials such as a metal, rubber, ceramic, and/or composite.

The cable passage 112 is configured to receive at least a portion of one or more of the cables 20 (e.g., the flat cables 22A, 22B). The cable passage 112 is defined by and between the base 150 (e.g., the base body 152 and/or the two side walls 154, 154′) and the cover 120 (e.g., the main body 120 and/or one or more walls 132, 132′). The cable passage 112 opens into the cable opening 124 (e.g., in the Z-direction) of the cover 120 and has open ends that face in an extension direction of the cables 20 (e.g., in the X-direction). The cable passage 112 of each of the plurality of modules 110₁-110₆ of the channel assembly 100 collectively form and/or define at least a portion of the common cable channel 102 (e.g., the first channel portion 102A).

As generally illustrated in FIGS. 2, 3, and 6, the cover 120 has a generally rectangular configuration, among other possible configurations. The cover 120 includes a main body 122, one or more walls 130, 130′, 132, 132′, and one or more cover fasteners 140, 140′. The main body 122, walls 130, 130′, 132, 132′, and cover fasteners 140, 140′ of the cover 120 are integrally formed with one another such that the cover 120 is a monolithic component. Alternatively, one or more of main body 122, walls 130, 130′, 132, 132′, and/or cover fasteners 140, 140′ may be structured separately/independently and attached to one another to form the cover 120.

As generally illustrated in FIGS. 2, 3, and 6, the main body 122 of the cover 120 has a generally rectangular shape. The main body 122 includes and/or defines a cable opening 124 configured to receive at least a portion of one or more of the cables 20 (e.g., the non-flat cables 24A-24C). The cable opening 124 opens into the cable passage 112 (e.g., in the Z-direction) and has open ends that face in an extension direction of the cables 20 (e.g., in the X-direction). As generally illustrated in FIG. 6, in at least some embodiments, one or more of the cables 20 (e.g., the second flat cable 22B) at least partially closes the cable opening 124 to, in conjunction with the main body 122, form and/or define at least a section of the second channel portion 102B. The cable opening 124 of each of the plurality of modules 110₁-110₆ of the channel assembly 100 collectively form and/or define at least a portion of the common cable channel 102 (e.g., the second channel portion 102B).

As generally illustrated in FIGS. 2, 3, and 6-8, the cover 102 and/or the main body 122 includes one or more walls. The walls include one or more outer side walls (e.g., a first outer side wall 130 and a second outer side wall 130′) and one or more inner side walls (e.g., a first inner side wall 132 and a second inner side wall 132′). The walls 130, 130′, 132, 132′ project perpendicularly or obliquely from one or more portions of the main body 122 (e.g., generally in the Z-direction). The first side walls 130, 132 and the second side walls 130′, 132′ are disposed at or about opposite ends of the main body 122 and/or the cover 120. The inner side walls 132, 132′ extend substantially parallel to and are inwardly offset (e.g., toward the cable opening 124 in the Y-direction) from the outer side walls 130, 130′.

When the cover 120 is disposed on and connected to the base 150, the outer side walls 130, 130′ are each at least partially disposed in a respective recess 156, 156′ of the base 150 and the inner side walls 132, 132′ are disposed adjacent to and/or in contact with a respective side wall 154, 154′ of the base 150. Optionally, when one or more cables 20 are disposed in the cable passage 112 and the cover 120 is disposed on and connected to the base 150, the main body 122 and/or one or more inner side walls 132, 132′ may contact, rest on, and/or press one or more of the cables 20 (e.g., flat cables 22A, 22B) against the base 150 and/or the base body 152, which may reduce and/or restrict movement of one or more of the cables 20 (e.g., flat cables 22A, 22B) within the cable passage 112, within the cable opening 124, within the common cable channel 102, and/or relative to the module 110 (e.g., relative to the cover 120 and/or the base 150).

As generally illustrated in FIGS. 2, 3, and 6-8, the cover 120 includes a plurality of cover fasteners (e.g., a first cover fastener 140 and a second cover fastener 140′) configured to engage a respective base fastener 160, 160′ of the base 150 to releasably and removably connect the cover 120 and the base 150. The cover fasteners 140, 140′ extend and/or protrude from the cover 120, such as generally away from one or more portions of the main body 122 and/or toward the base 150 (e.g., generally in a Z-direction). The cover fasteners 140, 140′ are configured to adjust, deflect, flex, etc. to engage and/or disengage the respective base fastener 160, 160′ to connect and/or disconnect the cover 120 and the base 150. The cover fasteners 140, 140′ are generally U-shaped and/or handle-shaped, which may allow a user to more easily grip and or actuate the cover fasteners 140, 140′ (e.g., to disconnect the cover 120 and the base 150). The cover fasteners 140, 140′ may have one or more other shapes in other embodiments.

Each cover fastener 140, 140′ includes one or more latch projections (e.g., one or more first latch projections 142A, 142B, one or more second latch projections 142A′, 142B′) configured to engage one or more tabs 162A-162C, 162A′-162C′ of the respective base fastener 160, 160′. In some embodiments, the latch projections 142A, 142B, 142A′, 142B′ may be configured for rachet engagement on one or more tabs 162A-162C, 162A′-162C′ of the respective base fastener 160, 160′. The latch projections 142A, 142B, 142A′, 142B′ extend and/or protrude inwardly from the cover fastener 140, 140′ generally toward the cable opening 124 and/or an inner side wall 132, 132′ adjacent thereto (e.g., generally in the Y-direction).

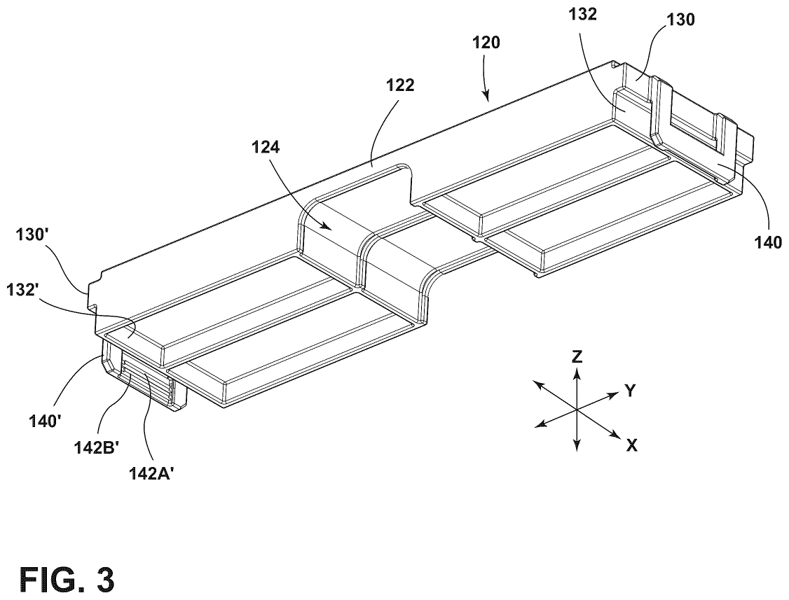

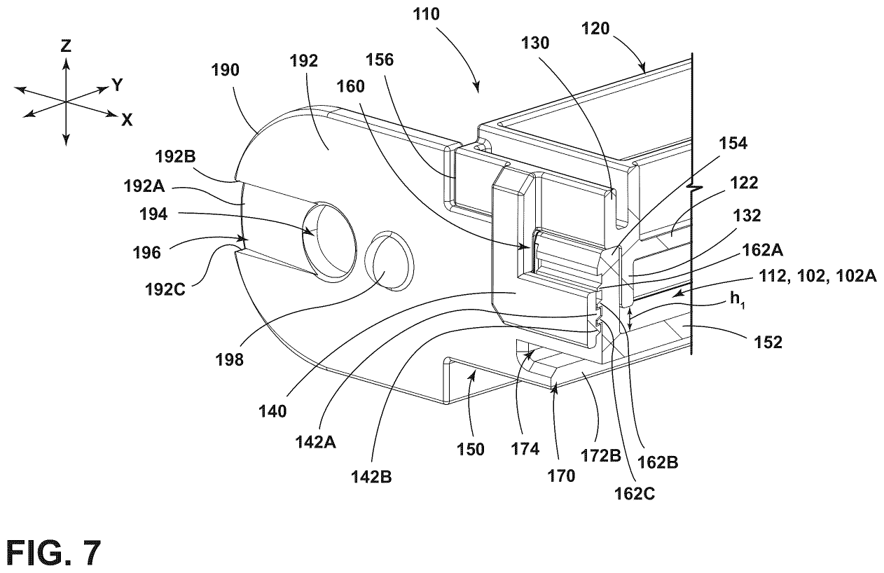

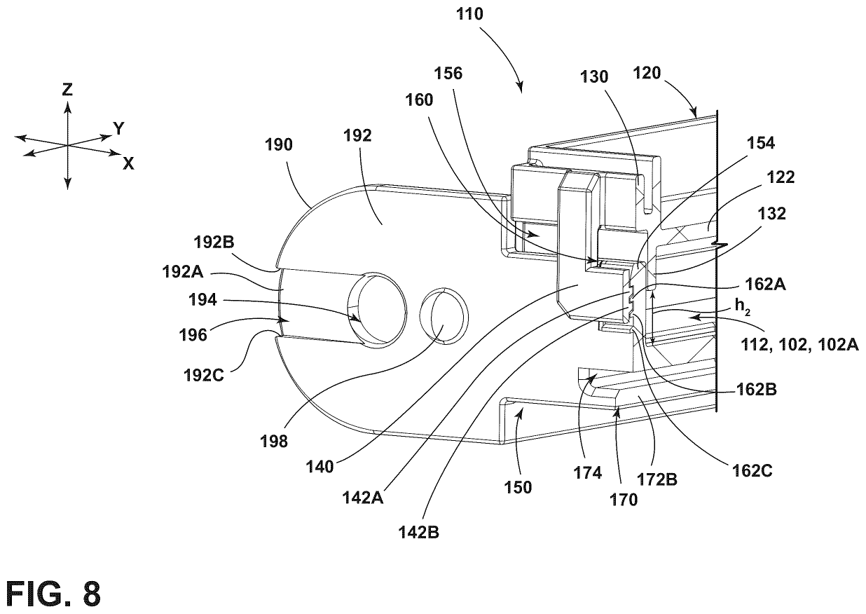

As generally illustrated in FIGS. 7 and 8, the first cover fastener 140 includes one or more first latch projections 142A, 142B and is disposed on, attached to, and/or extends from an outward facing surface of the first outer side wall 130. As generally illustrated in FIG. 3, the second cover fastener 140′ includes one or more second latch projections 142A′, 142B′ and is disposed on, attached to, and/or extends from an outward facing surface of the second outer side wall 130′.

As generally illustrated in FIGS. 2 and 4-6, the base 150 has a generally rectangular configuration, among other possible configurations. The base 150 includes a base body 152, one or more walls 154, 154′, one or more base fasteners 160, 160′, one or more connectors 180, 180′, 190, 190′, and one or more attachment formations 170, 170′. The base body 152, walls 154, 154′, base fasteners 160, 160′, connectors 180, 180′, 190, 190′, and attachment formations 170, 170′ of the base 150 are integrally formed with one another such that the base 150 is a monolithic component. Alternatively, one or more of base body 152, walls 154, 154′, base fasteners 160, 160′, connectors 180, 180′, 190, 190′, and attachment formations 170, 170′ may be structured separately/independently and attached to one another to form the base 150.

As generally illustrated in FIGS. 2 and 4-8, the base 150 (e.g., the base body 152 and/or one or more side walls 154, 154′ thereof) includes one or more attachment formations 170, 170′ configured to engage an attachment 106 to, for example, connect the attachment 106 to the base 150, the module 110, and/or the channel assembly 100. The attachment formation 170, 170′ includes one or more opposing L-shaped projections 172A, 172B, 172A′, 172B′ that project from the base body 152 away from the cover 120 and/or the cable passage 112. The L-shaped projections 172A, 172B, 172A′, 172B′ define an attachment receptacle 174, 174′ configured to receive at least a portion of an attachment 106. The attachment formation 170, 170′ also includes a projection and/or a latching nose 176, 176′ configured to engage (e.g., snap into engagement with) an attachment 106. The latching nose 176, 176′ is disposed adjacent to the L-shaped projections 172A, 172B, 172A′, 172B′ and, in some embodiments, may project into the attachment receptacle 174, 174′.

As generally illustrated in FIGS. 2 and 4-6, the base body 152 of the base 150 is generally planar and has a generally rectangular shape. The base body 152 extends substantially perpendicular or obliquely to the Z-direction.

As generally illustrated in FIGS. 2 and 4-8, the base 150 includes two side walls (e.g., a first side wall 154 and a second side wall 154′). The side walls 154, 154′ project perpendicularly or obliquely from the base body 152 (e.g., generally in the Z-direction). The side walls 154, 154′ are disposed at or about opposite ends of the base body 152 and/or the base 150. As generally illustrated in FIGS. 2 and 6-8, when the cover 120 is disposed on and connected to the base 150, the side walls 154, 154′ are each at least partially disposed between a respective cover fastener 140, 140′ and a respective inner side wall 132, 132′ of the cover 120.

As generally illustrated in FIGS. 2 and 4-8, the base 150 and/or the side walls 154, 154′ each include a recess (e.g., a first recess 156 and a second recess 156′) configured to receive at least a portion of a respective outer side wall 130, 130′ of the cover 120. The recess 156, 156′ is configured as a notch that extends into the side wall 154, 154′ toward the base body 152 (e.g., generally in the Z-direction) from an upper edge of the side wall 154, 154′. A depth of the recess 156, 156′ (e.g., generally in the Z-direction) generally corresponds to and/or is substantially equal to the height of the respective outer side wall 130, 130′ of the cover 120 that is to be received therein. The recess 156, 156′ is disposed in and/or defined by the side wall 154, 154′, the front connector 180, 180′, and/or the rear connector 190, 190′. For example, the recess 156, 156′ is disposed in the side wall 154, 154′ between at least a portion of the front connector 180, 180′ (e.g., the pivot projection 184, 184′) and at least a portion of the rear connector 190, 190′ (e.g., the pivot opening 194, 194′).

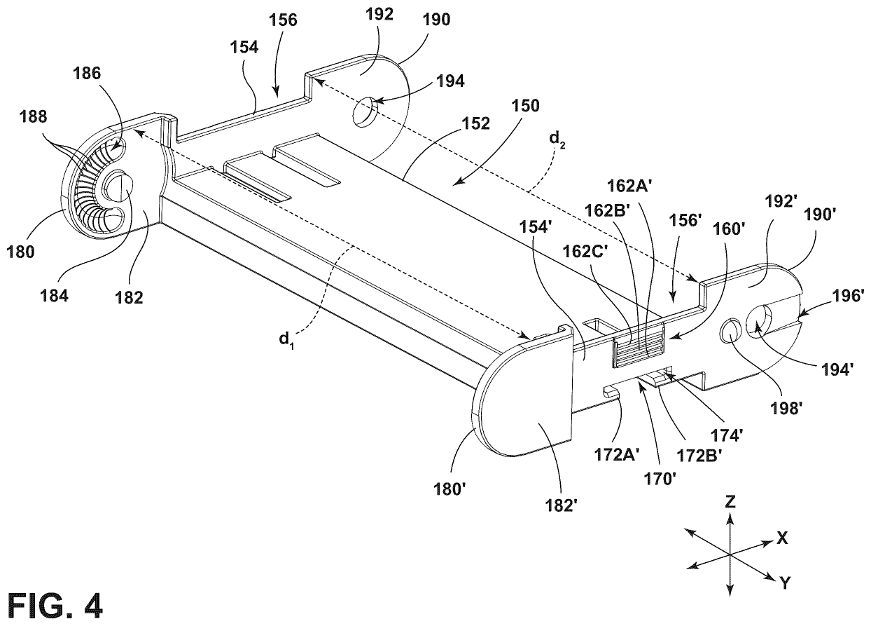

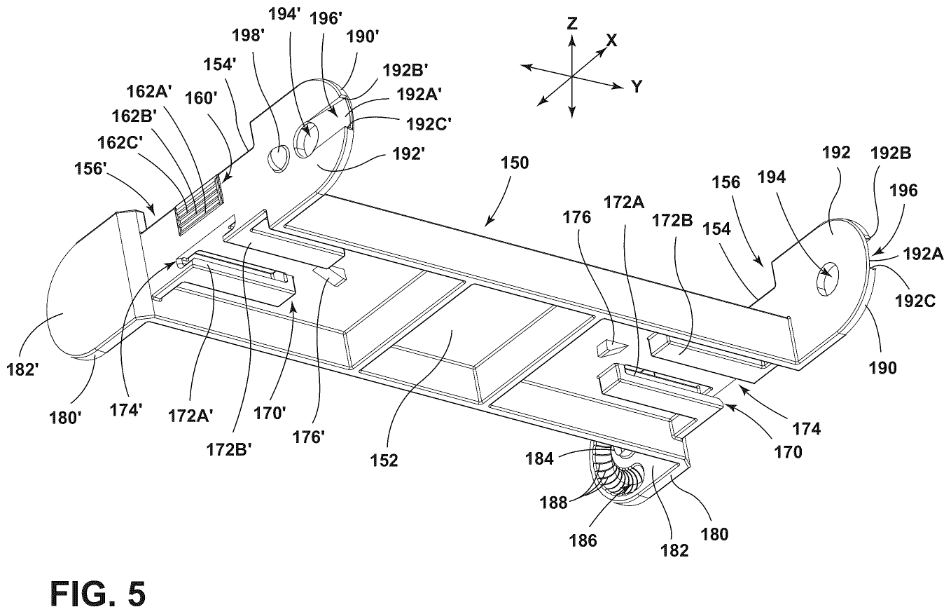

As generally illustrated in FIGS. 2 and 4-8, the base 150 and/or the side walls 154, 154′ each include a base fastener (e.g., a first base fastener 160 and a second base fastener 160′) configured to engage a respective cover fastener 140, 140′ to releasably and removably connect the cover 120 and the base 150. The first base fastener 160 is disposed on and/or attached to the first side wall 154 at, about, and/or adjacent to a bottom of the first recess 156 (see, e.g., FIGS. 2, 7, and 8). The second base fastener 160′ is disposed on and/or attached to the second side wall 154′ at, about, and/or adjacent to a bottom of the second recess 156′ (sec, e.g., FIGS. 4 and 5). The base fasteners 160, 160′ each include one or more tabs (e.g., one or more first tabs 162A, 162B, 162C; one or more second tabs 162A′, 162B′, 162C′) that extend and/or protrude outwardly from an outward facing surface of the respective side wall 154, 154′ (e.g., generally in the Y-direction). The first tabs 162A, 162B, 162C of the first base fastener 160 are disposed one above another (e.g., generally in the Z-direction) to define and/or form a first column of tabs (see, e.g., FIGS. 7 and 8). The second tabs 162A′, 162B′, 162C′ of the second base fastener 160′ are disposed one above another (e.g., generally in the Z-direction) to define and/or form a second column of tabs (see, e.g., FIGS. 4 and 5).

A position of the cover 120 relative to the base 150, a proportion of the outer side walls 130, 130′ that is disposed in the recesses, and a size and/or one or more dimensions of the cable passage 112 (e.g., a height, volume, cross-sectional area) varies based on the engagement of the cover fasteners 140, 140′ and the base fasteners 160, 160′ (e.g., based on which tab(s) 162A-162C, 162′-162C′ of the base fasteners 160, 160′ are engaged by one or more latching protrusions 142A, 142B, 142A′, 142B′ of the cover fasteners 140, 140′). For example, as generally illustrated in FIGS. 6 and 7, when the latching protrusions 142A, 142B, 142A′, 142B′ of each of the cover fasteners 140, 140′ are engaged with a tab 162C, 162C′ (e.g., disposed furthest from the recess 156, 156′) of a respective base fastener 160, 160′, the cover 120 is disposed in a first position relative to the base 150, the outer side walls 130, 130′ are disposed completely in the recesses 156, 156′, and the cable passage 112 has a first size (e.g., a first height h₁, volume, and/or cross-sectional area). When the latching protrusions 142A, 142B, 142A′, 142B′ of each cover fastener 140, 140′ is engaged with a different tab 162A, 162A′ (e.g., disposed closest to the recess 156, 156′) of a respective base fastener 160, 160′, as generally illustrated in FIG. 8, the cover 120 is disposed in a second position relative to the base 150, the outer side walls 130, 130′ are only partially disposed in the recesses 156, 156′, and the cable passage 112 has a larger, second size (e.g., a second height h₂, volume, and/or cross-sectional area). As the size and/or one or more dimensions of the cable passage 112 of each individual module 110 is adjustable, the channel assembly 100 and/or the common cable channel 102 is able to accommodate different quantities of cables 20, cables 20 of a variety of different shapes and sizes (e.g., thicknesses), and even cables 20 that vary in size along their length.

As generally illustrated in FIGS. 2 and 4-8, the base 150 includes a plurality of connectors, such as one or more front connectors (e.g., a first front connector 180 and a second front connector 180′) and one or more rear connectors (e.g., a first rear connector 190 and a second rear connector 190′). The first front connector 180 and the first rear connector 190 are disposed on, attached to, and/or project from opposite ends of the first side wall 154 and are disposed at least partially offset from one another (e.g., generally in the Y-direction). The second front connector 180′ and the second rear connector 190′ are disposed on, attached to, and/or project from opposite ends of the second side wall 154′ and are disposed at least partially offset from one another (e.g., generally in the Y-direction).

The front connectors 180, 180′ are each configured to pivotably and releasably engage one or more rear connectors 190, 190′ (e.g., of an adjacent module 110). The front connectors 180, 180′ of a module 110 may be configured substantially similar (e.g., identical) to one another and/or differently than one another. One or more front connectors 180, 180′ of a module 110 may, additionally and/or alternatively, be configured substantially similar (e.g., identical) to one or more front connectors 180, 180′ of one or more other modules 110 and/or differently than one or more front connectors 180, 180′ of one or more other modules 110.

The rear connectors 190, 190′ are each configured to pivotably and releasably engage one or more front connectors 180, 180′ (e.g., of an adjacent module 110). The rear connectors 190, 190′ of a module 110 may be configured substantially similar (e.g., identical) to one another and/or differently than one another. One or more rear connectors 190, 190′ of a module 110 may, additionally and/or alternatively, be configured substantially similar (e.g., identical) to one or more rear connectors 190, 190′ of one or more other modules 110 and/or differently than one or more rear connectors 190, 190′ of one or more other modules 110.

As generally illustrated in FIGS. 2 and 4-8, the front connector 180, 180′ includes a front connector body 182, 182′. The front connector body 182, 182′ is a generally planar body that is disposed on, attached to, and/or projects from a front end the side wall 154, 154′ and/or a front end of the base body 152. In at least some examples, the front connector body 182, 182′ may be a portion of and/or defined by the side wall 154, 154′. The front connector body 182, 182′ extends and/or projects beyond the front end and/or a front edge of the base body 152 (e.g., generally in the X-direction). The front connector body 182, 182′ is disposed outwardly offset (e.g., away from the base body 152, laterally, and/or generally in the Y-direction) from the rear connector 190, 190′ and/or the side wall 154, 154′ such that, for example, a distance d₁ (e.g., in the Y-direction) between the inward facing surfaces of the front connectors 180, 180′ is greater than a distance d₂ (e.g., in the Y-direction) between the outward facing surfaces of the rear connectors 190, 190′ and/or the side walls 154, 154′.

As generally illustrated in FIGS. 2, 4, and 5, the front connector 180, 180′ includes a pivot projection 184, 184′ configured to be received in and engage the pivot opening 194, 194′ of a rear connector 190, 190′ (e.g., of an adjacent module 110) to, for example, pivotably and releasably connect adjacent modules 110 (e.g., modules 110₁, 110₂) to one another. The pivot projection 184, 184′ is a generally cylindrical body that is disposed on, attached to, and/or projects inwardly (e.g., generally in the Y-direction) from the inward facing surface of the front connector body 182, 182′. The pivot projection 184, 184′ has an angled surface disposed at a free end that engages, contacts, and/or slides on one or more guide surfaces 192A, 192A′ of the rear connector 190, 190′ to facilitate (e.g., smooth) engagement of the pivot projection 184, 184′ with the pivot opening 194, 194′ of the rear connector 190, 190′. The pivot projections 184, 184′ of the front connectors 180, 180′ are disposed substantially coaxially with one another.

As generally illustrated in FIGS. 2, 4, and 5, the front connector 180, 180′ includes a groove 186, 186′ configured to receive and engage the protrusion 198, 198′ of a rear connector 190, 190′ (e.g., of an adjacent module 110) to, for example, facilitate, guide, and/or restrict adjustment (e.g., pivotal and/or rotational movement) of adjacent modules 110 (e.g., modules 110₁, 110₂) relative to one another. The groove 186, 186′ is defined by and projects into the front connector body 182, 182′ (e.g., laterally, and/or generally in the Y-direction). The groove 186, 186′ is disposed in the inward facing surface of the front connector body 182, 182′ and does not extend completely through the front connector body 182, 182′ (e.g., in the Y-direction). In other embodiments however, the groove 186, 186′ may extend completely through the front connector body 182, 182′ (e.g., in the Y-direction). The groove 186, 186′ extends at least partially around the pivot projection 184, 184′ (e.g., in a circumferential direction relative to the pivot projection 184, 184′) and generally has and/or forms a C-shape.

As generally illustrated in FIGS. 2, 4, and 5, the groove 186, 186′ is a ribbed groove that, at least to an extent (e.g., until a force threshold is overcome), maintains the position and/or orientation of adjacent modules 110 (e.g., modules 110₁, 110₂) relative to one another such as by resisting adjustment and/or movement of adjacent modules 110 relative to one another. The ribbed groove 186, 186′ includes one or more ribs 188, 188′ that extend transversely (e.g., obliquely or perpendicularly) relative to a longitudinal direction and/or a longitudinal extent of the ribbed groove 186, 186′ and that are disposed spaced apart from one another along the longitudinal direction and/or the longitudinal extent of the ribbed groove 186, 186′. The ribs 188, 188′ contact and/or engage a protrusion 198, 198′ (e.g., of a rear connector 190, 190′ of the adjacent module 110) that is disposed in the ribbed groove 186, 186′ to resist adjustment and/or movement of the protrusion 198, 198′ within the ribbed groove 186, 186′, which in turn resists adjustment and/or movement of adjacent modules 110 relative to one another. Only a subset of the ribs 188, 188′ (e.g., the one and/or two ribs 188, 188′ disposed directly adjacent to the protrusion 198, 198′) contact and/or engage the protrusion 198, 198′ disposed within the ribbed groove 186, 186′ at a given time, and the subset of ribs 188, 188′ contacting and/or engaging the protrusion 198, 198′ varies based on a position of the protrusion 198, 198′ within the ribbed groove 186, 186′.

As generally illustrated in FIGS. 2 and 4-8, the rear connector 190, 190′ includes a rear connector body 192, 192′. The rear connector body 192, 192′ is a generally planar body that is disposed on, attached to, and/or projects from a rear end the side wall 154, 154′ and/or a rear end of the base body 152. In at least some examples, the rear connector body 192, 192′ may be a portion of and/or defined by the side wall 154, 154′. The rear connector body 192, 192′ extends and/or projects beyond the rear end and/or a rear edge of the base body 152 (e.g., generally in the X-direction).

As generally illustrated in FIGS. 2 and 4-8, the rear connector 190, 190′ includes a pivot opening 194, 194′ configured to receive and engage the pivot projection 184, 184′ of a front connector 180, 180′ (e.g., of an adjacent module 110) to, for example, pivotably and releasably connect adjacent modules 110 (e.g., modules 110₁, 110₂) to one another. The pivot opening 194, 194′ is configured complimentary to the pivot projection 184, 184′. The pivot opening 194, 194′ is defined by and projects into the rear connector body 192, 192′ (e.g., generally in the Y-direction). The pivot opening 194, 194′ is disposed in the outward facing surface of the rear connector body 192, 192′ and, optionally, extends completely through the rear connector body 192, 192′ (e.g., in the Y-direction). In other embodiments, the pivot opening 194, 194′ may not extend completely through the rear connector body 192, 192′ (e.g., in the Y-direction). The pivot openings 194, 194′ of the two rear connectors 190, 190′ are disposed substantially coaxially with one another and/or, when engaged by the pivot projections 184, 184′, the pivot projections 184, 184′.

As generally illustrated in FIGS. 5, 7, and 8, the rear connector 190, 190′ includes one or more guide surfaces 192A, 192B, 192C, 192A′, 192B′, 192C′ configured to contact and/or engage the pivot projection 184, 184′ of a front connector 180, 180′ (e.g., of an adjacent module 110) to, for example, guide the pivot projection 184, 184′ into engagement with the pivot opening 194, 194′ when connecting adjacent modules 110 (e.g., modules 110₁, 110₂). The guide surfaces 192A-192C, 192A′-192C′ are each defined by one or more surfaces of the rear connector body 192, 192′. The guide surfaces 192A-192C, 192A′-192C′ are recessed into the rear connector body 192, 192′ and define a channel 196, 196′. Alternatively, the guide surfaces 192A-192C, 192A′-192C′ may not define a channel and/or may project outward from the rear connector body 192, 192′ in other embodiments. The guide surfaces 192A-192C, 192A′-192C′ extend longitudinally from the pivot opening 194, 194′ to and/or out through an end and/or edge of the rear connector body 192, 192′. One or more of the guide surfaces 192A-192C, 192A′-192C′ (e.g., the guide surface 192A, 192A′) is a sloped surface that projects further/deeper into the rear connector body 192, 192A (e.g., in the Y-direction) as the guide surface 192A, 192A′ extends from the pivot opening 194, 194′ toward the edge of the rear connector body 192, 192′. The angled surface of the pivot projection 184, 184′ may engage, contact, and/or slide along one or more of the guide surfaces 192A, 192A′ to facilitate (e.g., smooth) engagement of the pivot projection 184, 184′ with the pivot opening 194, 194′ of the rear connector 190, 190′.

As generally illustrated in FIGS. 2 and 4-8, the rear connector 190, 190′ includes a channel 196, 196′ configured to receive and engage the pivot projection 184, 184′ of a front connector 180, 180′ (e.g., of an adjacent module 110) to, for example, guide the pivot projection 184, 184′ into engagement with the pivot opening 194, 194′ when connecting adjacent modules 110 (e.g., modules 110₁, 110₂). The channel 196, 196′ is defined by the rear connector body 192, 192′ (e.g., the guide surfaces 192A-192C, 192A′-192C′ thereof) and projects into the rear connector body 192, 192′ (e.g., generally in the Y-direction). The channel 196, 196′ is disposed in the outward facing surface of the rear connector body 192, 192′ and does not extend completely through the rear connector body 192, 192′ (e.g., in the Y-direction). In other embodiments, the channel 196, 196′ may extend completely through the rear connector body 192, 192′ (e.g., in the Y-direction). The channel 196, 196′ extends longitudinally from the pivot opening 194, 194′ to and/or out through an end and/or edge of the rear connector body 192, 192′. A depth of the channel 196, 196′ (e.g., in the Y-direction) increases as the channel 196, 196′ extends from the pivot opening 194, 194′ toward the edge of the rear connector body 192, 192′.

As generally illustrated in FIGS. 2 and 4-8, the rear connector 190, 190′ includes a protrusion 198, 198′ (e.g., a nub) configured to be received in and engage the groove 186, 186′ of a front connector 180, 180′ (e.g., of an adjacent module 110) to, for example, facilitate, guide, and/or restrict adjustment (e.g., pivotal and/or rotational movement) of adjacent modules 110 (e.g., modules 110₁, 110₂) relative to one another. The protrusion 198, 198′ is a generally dome-shaped body that is disposed on, attached to, and/or projects outwardly (e.g., generally in the Y-direction) from the outward facing surface of the rear connector body 192, 192′. Optionally, the protrusions 198, 198′ of the two rear connectors 190, 190′ are disposed coaxially with one another.

While embodiments are generally illustrated with the cover fasteners 140, 140′ including the latch projections 142A, 142B, 142A′, 142B′ and the base fasteners 160, 160′ including the column of tabs 162A, 162B, 162C, 162A′, 162B′, 162C′, embodiments may also include the opposite configuration (e.g., the cover fasteners 140, 140′ including the column of tabs 162A, 162B, 162C, 162A′, 162B′, 162C′ and the base fasteners 160, 160′ including the latch projections 142A, 142B, 142A′, 142B′) or a combination/mixture of such configurations (e.g., the first cover fastener 140 including the latch projections 142A, 142B, the second cover fastener including the column of tabs 162A′, 162B′, 162C′, the first base fastener 160 including the column of tabs 162A, 162B, 162C, and the second base fastener 160′ including the latch projections 142A′, 142B′). Similarly, while embodiments are generally illustrated with the front connectors 180, 180′ each including a variety of features and/or elements (e.g., connector body 182, 182′, pivot projection 184, 184′, ribbed groove 186, 186′) and the rear connectors 190, 190′ including a variety of other features and/or elements (e.g., connector body 192, 192′, pivot opening 194, 194′, channel 196, 196′, protrusion 198, 198′), embodiments may also include the opposite configuration or a combination/mixture of various configurations (e.g., the first front connector 180 including the pivot opening 194, the channel 196, and the ribbed groove 186, the first rear connector 190 including the pivot projection 184 and the protrusion 198, the second front connector 180′ including the pivot opening 194′, the channel 196′, and the protrusion 198′, and the second rear connector 190′ including the pivot projection 184′ and the ribbed groove 186′).

A module 110, 110₁-110₆ may be connected to one or more adjacent modules 110, 110₁-110₆. For example, in FIG. 1, the third module 110₃ is connected to the adjacent fourth module 110₄ and to the adjacent second module 110₂. The front connectors of the third module 110₃ are engaged with the rear connectors of the fourth module 110₄ thereby releasably and adjustably connecting the third module 110₃ and the fourth module 110₄. The rear connectors of the third module 110₃ are engaged with the front connectors of the second module 110₂ thereby releasably and adjustably connecting the third module 110₃ and the second module 110₂.

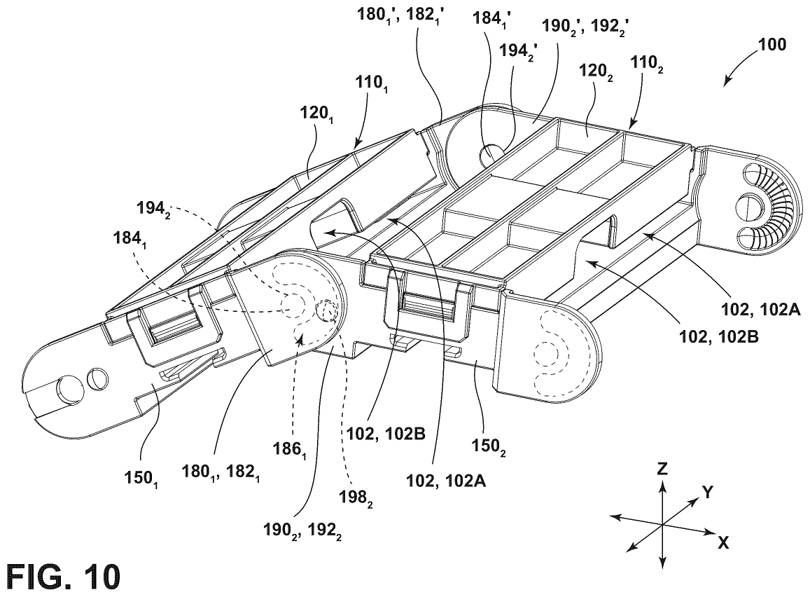

A pair of adjacent modules 110₁, 110₂ is depicted in FIGS. 9 and 10, which is representative of each pair of adjacent modules 110 of the channel assembly 100 (e.g., adjacent modules 110₂, 110₃, adjacent modules 110₃, 110₄, etc.). The pair of adjacent modules 110₁, 110₂ includes a first module 110₁ and a second module 110₂ each including a cover 120₁, 120₂ and a base 150₁, 150₂. The adjacent modules 110₁, 110₂ are pivotably and releasably connected to one another via the engagement of the front connectors 180₁, 180₁′ of the first module 110₁ and the rear connectors 190₂, 190₂′ of the second module 110₂. The inward facing surface of each first connector body 182₁, 182₁′ of the first module 110₁ faces the outward facing surface of the corresponding rear connector body 192₂, 192₂′ of the second module 110₂. The pivot projections 184₁, 184₁′ of the first module 110₁ are each disposed in the corresponding pivot opening 194₂, 194₂′ of the second module 110₂ pivotably and releasably connecting the first module 110₁ and the second module 110₂. The protrusions 198₂ of the second module 110₂ are each disposed within the corresponding ribbed groove 186₁ of the first module 110₁, which guides adjustment of the first module 110₁ and the second module 110₂ relative to one another. Engagement of the protrusions 198₂ of the second module 110₂ and the ribs of the ribbed grooves 186₁ of the first module 110₁ resists movement and/or adjustment of the protrusions 198₂ within the ribbed grooves 186₁ and, to at least an extent, maintains a position and orientation of the first module 110₁ and the second module 110₂ relative to one another. The position and/or orientation of the first module 110₁ and the second module 110₂ relative to one another is adjustable (e.g., to a first/linear position depicted in FIG. 9 and to a second/angled position depicted in FIG. 10, among others) by rotating and/or pivoting the modules 110₁, 110₂ relative to one another about the pivot projections 184₁, 184₁′. The adjacent modules 110₁, 110₂ are rotatable and/or pivotable about the pivot projections 184₁, 184₁′ by applying sufficient (e.g., rotational) force to overcome the resistance provided by the engagement of the protrusions 198₂ and the ribs and adjust/change the positions of the protrusions 198₂ within the ribbed grooves 186₁.

The disclosure includes, without limitation, the following embodiments:

1. A modular contour adaptive channel assembly, comprising a plurality of modules releasably and adjustably connected to one another in a chain-like manner to define a common cable channel, wherein: each module of the plurality of modules includes: a base; a cover removably disposed on the base; and a cable passage defined by and between the cover and the base; the base includes: a front connector; a rear connector; and a base fastener; the cover includes a cover fastener; the cover fastener and the base fastener are engaged with one another releasably connecting the cover and the base; adjacent modules of the plurality of modules are pivotably and releasably connected to one another via engagement of the front connector of a first module of the adjacent modules and the rear connector of a second module of the adjacent modules; and the cable passage of each of the plurality of modules collectively define the common cable channel.

2. The assembly according to embodiment 1, wherein: the cover fastener includes a latch projection; the base fastener includes a tab; and the latch projection and the tab are engaged with one another releasably connecting the cover and the base.

3. The assembly according to any of the preceding embodiments, wherein: the cover fastener includes a latch projection; the base fastener includes a plurality of tabs; the latch projection is engaged with at least one of the plurality of tabs releasably connecting the cover and the base; and a dimension of the cable passage varies based on which of the plurality of tabs is engaged by the latch projection.

4. The assembly according to any of the preceding embodiments, wherein the plurality of tabs are disposed one above another to define a column of tabs.

5. The assembly according to any of the preceding embodiments, wherein: the front connector includes a pivot projection; the rear connector includes a pivot opening complimentary to the pivot projection; and the pivot projection of the first module is disposed in the pivot opening of the second module pivotably and releasably connecting the first module and the second module.

6. The assembly according to any of the preceding embodiments, wherein: the rear connector includes a rear connector body and a guide surface; the pivot opening is disposed in the rear connector body; the rear connector body defines the guide surface; and the guide surface extends from an edge of the rear connector body to the pivot opening facilitating engagement of the pivot opening with the pivot projection of another module of the plurality of modules.

7. The assembly according to any of the preceding embodiments, wherein: the rear connector includes a rear connector body and a channel; the pivot opening and the channel are disposed in the rear connector body; and the channel extends from an edge of the rear connector body to the pivot opening facilitating engagement of the pivot opening with the pivot projection of another module of the plurality of modules.

8. The assembly according to any of the preceding embodiments, wherein: the front connector includes a front connector body and a groove disposed in the front connector body; the rear connector includes a protrusion; and the protrusion of the second module is disposed within the groove of the first module and guides adjustment of the first module and the second module relative to one another.

9. The assembly according to any of the preceding embodiments, wherein: the groove of the front connector is a ribbed groove; and engagement of the protrusion of the second module and at least one rib of the ribbed groove of the first module resists adjustment of the protrusion within the ribbed groove and, to at least an extent, maintains a position and orientation of the first module and the second module relative to one another.

10. The assembly according to any of the preceding embodiments, wherein: the front connector includes a pivot projection; the groove of the front connector extends at least partially around the pivot projection in a circumferential direction; the rear connector includes a pivot opening complimentary to the pivot projection; and the pivot projection of the first module is disposed in the pivot opening of the second module pivotably and releasably connecting the first module and the second module.

11. The assembly according to any of the preceding embodiments, wherein: the base includes a base body and a side wall extending from the base body; and the front connector and the rear connector are disposed at opposite ends of the side wall.

12. The assembly according to any of the preceding embodiments, wherein: the side wall includes a recess disposed between at least a portion of the front connector and at least a portion of the rear connector; and the cover includes an outer side wall at least a portion of which is disposed in the recess of the base.

13. The assembly according to any of the preceding embodiments, wherein the base fastener is disposed on the side wall of the base adjacent to a bottom of the recess.

14. The assembly according to any of the preceding embodiments, wherein: the cover fastener includes a latch projection; the base fastener includes a plurality of tabs; the latch projection is engaged with one of the plurality of tabs releasably connecting the cover and the base; the outer side wall is disposed completely in the recess when the latch projection is engaged with a first tab of the plurality of tabs and is disposed only partially in the recess when the latch projection is engaged with a second tab of the plurality of tabs; and the second tab is disposed farther from the bottom of the recess than the first tab.

15. The assembly according to any of the preceding embodiments, wherein the cover fastener projects from the outer side wall of the cover.

16. The assembly according to any of the preceding embodiments, wherein: the cover includes an inner side wall; and at least a portion of the side wall of the base is disposed between the cover fastener and the inner side wall of the cover.

17. The assembly according to any of the preceding embodiments, wherein the side wall of the base and the outer side wall of the cover are substantially aligned with one another.

18. The assembly according to any of the preceding embodiments, wherein the front connector and the rear connector are disposed at least partially offset from one another.

19. The assembly according to any of the preceding embodiments, wherein the cover includes a cable opening that at least partially defines a second common cable channel.

20. The assembly according to any of the preceding embodiments, including at least one attachment selectively and releasably connectable to the plurality of modules, wherein: the base includes an attachment formation via which the at least one attachment is releasably connectable to the base; and the at least one attachment is releasably connected to a module of the plurality of modules via the attachment formation of the module.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, front, frontward, rear, rearward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly. a second element could be termed a first element, without departing from the scope of the various described embodiments. The first element and the second element are both element, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. A modular contour adaptive channel assembly, comprising a plurality of modules releasably and adjustably connected to one another in a chain-like manner to define a common cable channel, wherein:
each module of the plurality of modules includes:
a base;
a cover removably disposed on the base; and
a cable passage defined by and between the cover and the base;
the base includes:
a front connector;
a rear connector; and
a base fastener;
the cover includes a cover fastener;
the cover fastener and the base fastener are engaged with one another releasably connecting the cover and the base;
adjacent modules of the plurality of modules are pivotably and releasably connected to one another via engagement of the front connector of a first module of the adjacent modules and the rear connector of a second module of the adjacent modules; and
the cable passage of each of the plurality of modules collectively define the common cable channel.

2. The assembly of claim 1, wherein:
the cover fastener includes a latch projection;
the base fastener includes a tab; and
the latch projection and the tab are engaged with one another releasably connecting the cover and the base.

3. The assembly of claim 1, wherein:
the cover fastener includes a latch projection;
the base fastener includes a plurality of tabs;
the latch projection is engaged with at least one of the plurality of tabs releasably connecting the cover and the base; and
a dimension of the cable passage varies based on which of the plurality of tabs is engaged by the latch projection.

4. The assembly of claim 3, wherein the plurality of tabs are disposed one above another to define a column of tabs.

5. The assembly of claim 1, wherein:
the front connector includes a pivot projection;
the rear connector includes a pivot opening complimentary to the pivot projection; and
the pivot projection of the first module is disposed in the pivot opening of the second module pivotably and releasably connecting the first module and the second module.

6. The assembly of claim 5, wherein:
the rear connector includes a rear connector body and a guide surface;
the pivot opening is disposed in the rear connector body;
the rear connector body defines the guide surface; and
the guide surface extends from an edge of the rear connector body to the pivot opening facilitating engagement of the pivot opening with the pivot projection of another module of the plurality of modules.

7. The assembly of claim 5, wherein:
the rear connector includes a rear connector body and a channel;
the pivot opening and the channel are disposed in the rear connector body; and
the channel extends from an edge of the rear connector body to the pivot opening facilitating engagement of the pivot opening with the pivot projection of another module of the plurality of modules.

8. The assembly of claim 1, wherein:
the front connector includes a front connector body and a groove disposed in the front connector body;
the rear connector includes a protrusion; and
the protrusion of the second module is disposed within the groove of the first module and guides adjustment of the first module and the second module relative to one another.

9. The assembly of claim 8, wherein:
the groove of the front connector is a ribbed groove; and
engagement of the protrusion of the second module and at least one rib of the ribbed groove of the first module resists adjustment of the protrusion within the ribbed groove and, to at least an extent, maintains a position and orientation of the first module and the second module relative to one another.

10. The assembly of claim 8, wherein:
the front connector includes a pivot projection;
the groove of the front connector extends at least partially around the pivot projection in a circumferential direction;
the rear connector includes a pivot opening complimentary to the pivot projection; and
the pivot projection of the first module is disposed in the pivot opening of the second module pivotably and releasably connecting the first module and the second module.

11. The assembly of claim 1, wherein:
the base includes a base body and a side wall extending from the base body; and
the front connector and the rear connector are disposed at opposite ends of the side wall.

12. The assembly of claim 11, wherein:
the side wall includes a recess disposed between at least a portion of the front connector and at least a portion of the rear connector; and
the cover includes an outer side wall at least a portion of which is disposed in the recess of the base.

13. The assembly of claim 12, wherein the base fastener is disposed on the side wall of the base adjacent to a bottom of the recess.

14. The assembly of claim 13, wherein:
the cover fastener includes a latch projection;
the base fastener includes a plurality of tabs;
the latch projection is engaged with one of the plurality of tabs releasably connecting the cover and the base;
the outer side wall is disposed completely in the recess when the latch projection is engaged with a first tab of the plurality of tabs and is disposed only partially in the recess when the latch projection is engaged with a second tab of the plurality of tabs; and
the second tab is disposed farther from the bottom of the recess than the first tab.

15. The assembly of claim 12, wherein the cover fastener projects from the outer side wall of the cover.

16. The assembly of claim 15, wherein:
the cover includes an inner side wall; and
at least a portion of the side wall of the base is disposed between the cover fastener and the inner side wall of the cover.

17. The assembly of claim 16, wherein the side wall of the base and the outer side wall of the cover are substantially aligned with one another.

18. The assembly of claim 11, wherein the front connector and the rear connector are disposed at least partially offset from one another.

19. The assembly of claim 1, wherein the cover includes a cable opening that at least partially defines a second common cable channel.

20. The assembly of claim 1, including at least one attachment selectively and releasably connectable to the plurality of modules, wherein:
the base includes an attachment formation via which the at least one attachment is releasably connectable to the base; and
the at least one attachment is releasably connected to a module of the plurality of modules via the attachment formation of the module.
